(19) United States
(12) Patent Application Publication
(10) Pub. No.: US 2018/0318155 A1
(43) Pub. Date: Nov. 8, 2018

(54) BENDABLE TRANSFERRING BED

(71) Applicants: Jinling Institute of Technology, NANJING (CN); Nanjing Kangni Precision Mechanics Co., Ltd, NANJING (CN)

(72) Inventors: LIMING ZHENG, NANJING (CN); BIN XIE, NANJING (CN); XIAOHU CHEN, NANJING (CN); HAIWEI ZHANG, NANJING (CN); MINGMING ZHANG, NANJING (CN); YU GUO, NANJING (CN); YUNHUI CHEN, NANJING (CN)

(73) Assignees: Jinling Institute of Technology, NANJING (CN); Nanjing Kangni Precision Mechanics Co., Ltd, NANJING (CN)

(21) Appl. No.: 15/800,156

(22) Filed: Nov. 1, 2017

(30) Foreign Application Priority Data
May 8, 2017 (CN) 201710318651.9

(51) Int. Cl. A61G 1/013; A61G 1/02; A61G 1/017

(52) U.S. Cl. CPC A61G 1/013; A61G 5/006; A61G 1/017; A61G 1/02

(57) ABSTRACT

A bendable transferring bed has a bed frame, multiple bed-panel units, and at least one coupling. Each two adjacent ones of the bed-panel units are pivotally connected to each other. Each bed-panel units has a moveable bed-panel and a transmission shaft. The moveable bed-panel is moved relative to the mounting frame through the rotating of the transmission shaft. The two transmission shafts of each two adjacent ones of the bed-panel units are connected by one of the couplings, and thus the moveable bed-panels of all the bed-panel units can be moved together. The moveable bed-panels of the bed-panel units are bendable relative to each other to keep the patient in a sitting position or other positions. The moveable bed-panels can be moved when the moveable bed-panels are bent relative to each other by the coupling, such that the patient can be moved when in the sitting position.

### BACKGROUND OF THE INVENTION

### 1. Field of the Invention

The present invention relates to a bendable transferring bed, especially to a bendable transferring bed for moving a patient.

### 2. Description of the Prior Arts

The transferring bed, which is also called a transferring stretcher, is a bed that is movable to move a patient, and to be precise, to move a patient in need of mobility aid between the hospital bed and the operating table or between different hospital beds.

The transferring bed has a bed frame and a moveable bed-panel. The bed frame has multiple wheels on a bottom of the bed frame, such that the transferring bed is moveable by push. The moveable bed-panel is transversely movably mounted on the bed frame. The moveable bed-panel can be moved inwardly to be disposed above the bed frame, or can be moved outwardly to be disposed on a side of the bed frame.

When the transferring bed is in use, the transferring bed is moved to be next to the operating table, and then the moveable bed-panel is transversely moved out to insert between a back of the patient and the operating table. Afterwards, the moveable bed-panel and the patient together are moved back to the bed frame. Then the patient is moved to be next to the hospital bed via the transferring bed, and the moveable bed-panel is transversely moved out to be disposed above the hospital bed. Finally, the moveable bed-panel is gradually moved back while the patient is gradually repositioned downward on the hospital bed, thereby achieving the transferring of the patient.

However, the transferring bed has the following shortcomings. The moveable bed-panel is a flat panel, and thus the patient needs to keep lying down. However, some of the patients need to keep in a sitting position. For example, the sitting position is helpful in the delivery of the tissue fluid of the chest or is helpful to excrete the body fluid for a patient who is suffering heart diseases.

In addition, when the patient is lying down, the vision of the patient is greatly limited, and thus the patient cannot operate or control the transferring bed by himself alone.

As a result, the conventional transferring bed needs to be improved.

To overcome the shortcomings, the present invention provides a bendable transferring bed to mitigate or obviate the aforementioned problems.

### SUMMARY OF THE INVENTION

The main objective of the present invention is to provide a bendable transferring bed having multiple bed-panels that can be moved when the bed-panels are bent relative to each other.

The bendable transferring bed has a bed frame, multiple bed-panel units, at least one coupling, and a bed-panel power device. The bed-panel units are mounted on the bed frame, and are linearly aligned. Each two adjacent ones of the bed-panel units are pivotally connected to each other. Each one of the bed-panel units has a mounting frame, a moveable bed-panel, and a transmission shaft. The mounting frame is mounted on the bed frame. The moveable bed-panel is movably mounted on the mounting frame. The transmission shaft is rotatably mounted on the moveable bed-panel. The moveable bed-panel is moved relative to the mounting frame through the rotating of the transmission shaft. The two transmission shafts of each two adjacent ones of the bed-panel units are connected by one of the at least one coupling. The bed-panel power device is mounted on one of the bed-panel units, and rotates the transmission shaft of said bed-panel unit.

The present invention divides the bed panel into multiple bed-panel units, and the moveable bed-panels of the bed-panel units are pivotally connected to each other. Thus, the moveable bed-panels of the bed-panel units are bendable relative to each other to keep the patient: in a sitting position or other positions. No matter how to relatively bend the moveable bed-panels of the bed-panel units, the moveable bed-panels of all the bed-panel units can be moved together since the transmission shafts of the bed-panel units are connected by a coupling. Therefore, the transmission shafts of all the bed-panel units can be rotated simultaneously by one single power device, thereby moving the moveable bed-panels of all the bed-panel units together. The present invention provides multiple moveable bed-panels that can be moved when the moveable bed-panels are bent relative to each other, such that the patient can be moved when in a sitting position.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bendable transferring bed in accordance with the present invention;

FIG. 2 is an exploded perspective view of the bendable transferring bed in FIG. 1;

FIG. 3 is a perspective view of the bendable transferring bed in FIG. 1, showing a connection between two bed-panel units;

FIG. 4 is an exploded perspective view of a universal joint (coupling) of the bendable transferring bed in FIG. 1;

FIGS. 5 and 6 are exploded perspective views of the bed-panel unit of the bendable transferring bed in FIG. 1;

FIG. 7 is a side view of the bed-panel unit of the bendable transferring bed in FIG. 1, showing gears engaging with each other;

FIG. 8 is a perspective view in partial section of the bed-panel unit of the bendable transferring bed in FIG. 1;

FIG. 9 is a perspective view of a bed-panel power device of the bed-panel unit of the bendable transferring bed in FIG. 1;

FIGS. 10 and 11 are respectively top views of the bed-panel unit of the bendable transferring bed in FIG. 1, showing a clutch between a transmission shaft and a driven shaft;

FIG. 12 is a side view in partial section of an upper looped belt and a lower looped belt of the bendable transferring bed in FIG. 1;

FIGS. 13 to 16 are respectively operational side views of four moving stages of the moveable bed-panel of the bendable transferring bed in FIG. 1;

FIG. 17 is an operational view of the bendable transferring bed in FIG. 1;

FIG. 18 is a side view of another embodiment of the bendable transferring bed in FIG. 1, showing five bed-panel units;

FIG. 19 is a perspective view of a bed frame of still another embodiment of the bendable transferring bed in FIG. 1;

FIG. 20 is a side view of the bed frame of still another embodiment of the bendable transferring bed in FIG. 1;

FIG. 21 is a schematic view of the ports of the bendable transferring bed in FIG. 1;

FIG. 22 is a schematic view of the bendable transferring bed in FIG. 1, shown connected with a common clinical medical equipment;

FIG. 23 is a perspective view of a flexible universal shaft connector (coupling) of the bendable transferring bed in FIG. 1;

FIG. 24 is a perspective view of a spring universal shaft connector (coupling) of the bendable transferring bed in FIG. 1;

FIG. 25 is a perspective view of a constant velocity joint (coupling) of the bendable transferring bed in FIG. 1;

FIG. 26 is a top view of multiple (pressure sensors of the bendable transferring bed in FIG. 1;

FIG. 27 is a perspective view of the bendable transferring bed in FIG. 1, showing two mounting frames pivotally connected to each other; and

FIGS. 28 and 29 are respectively side views of the bed frame of further another embodiment of the bendable transferring bed in FIG. 1.

### DETAILED DESCRIPTION OF THE PREFERRED EMBODIMENTS

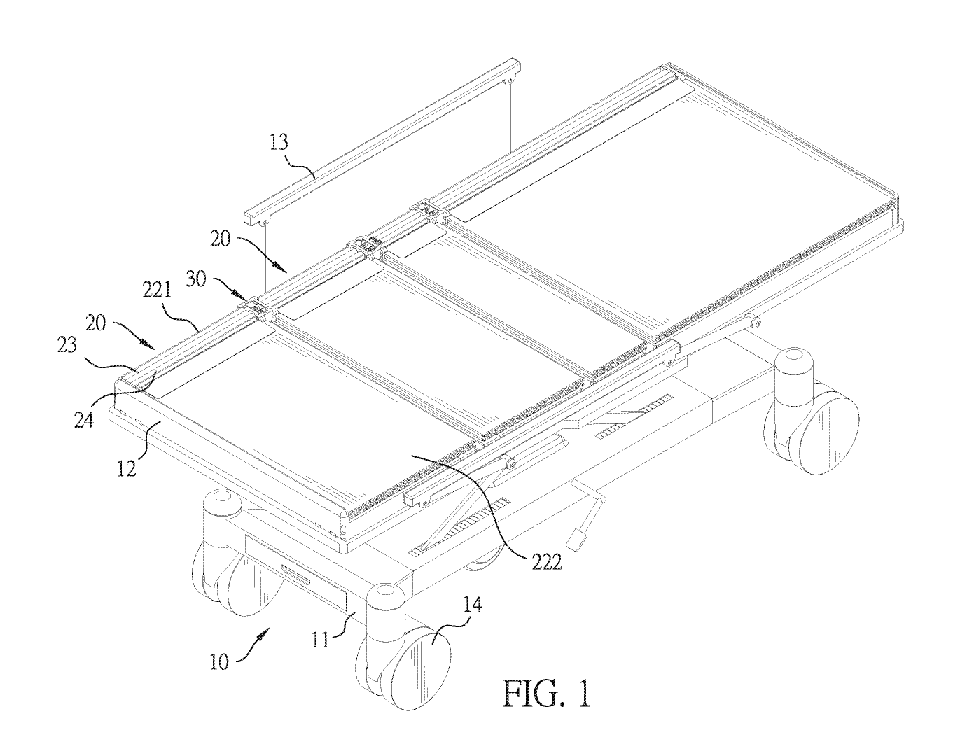

With reference to FIGS. 1, 2, and 5, a bendable transferring bed in accordance with the present invention comprises a bed frame 10, multiple bed-panel units 20, multiple couplings 30, a bed-panel power device 40, and a clutch 50.

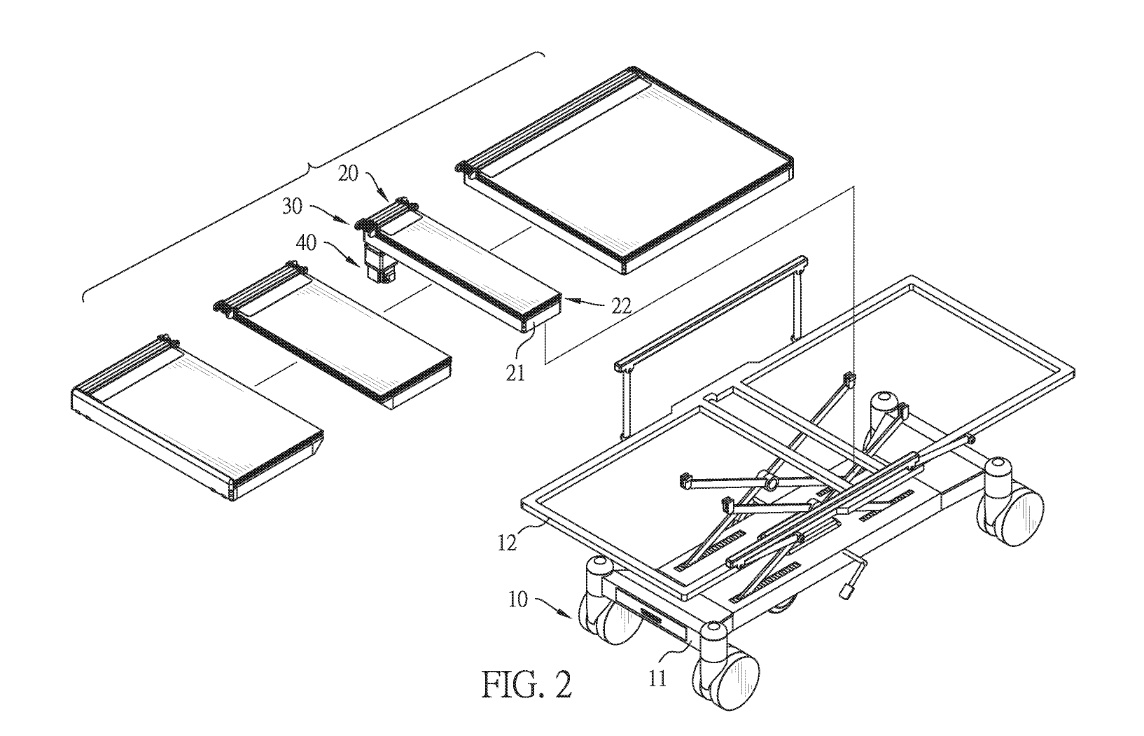

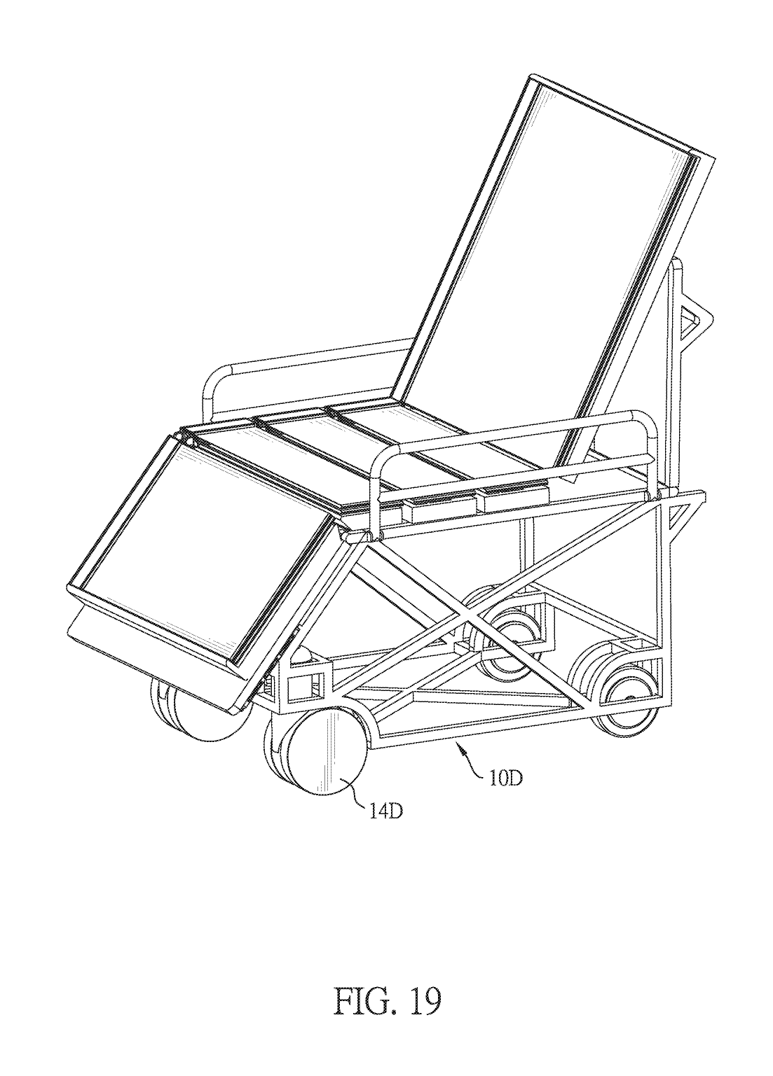

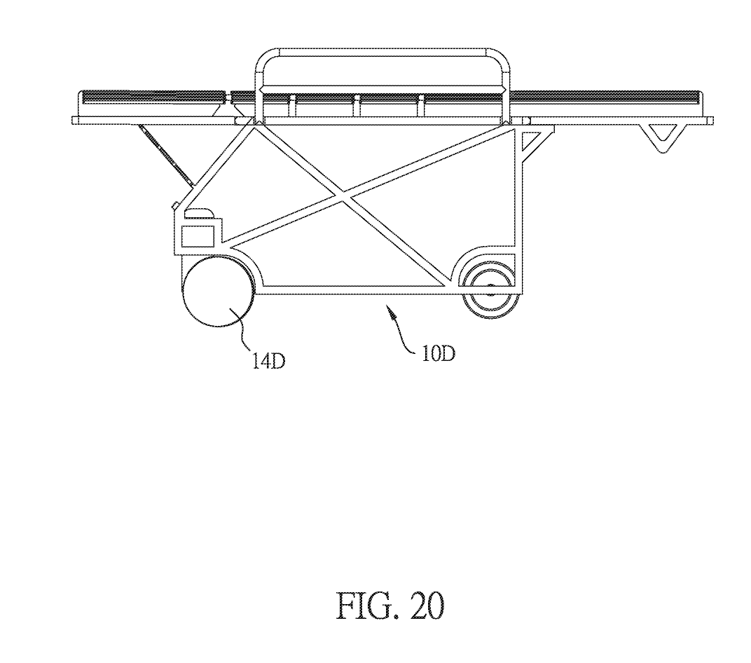

With reference to FIG. 2, the bed frame 10 has a base 11, a top seat 12, two armrests 13, and multiple rollers 14. The top seat 112 is mounted on and is elevatable relative to the base 11. The two armrests 13 are respectively mounted on two transverse sides of the top seat 12, and are tiltable relative to the top seat 12. The rollers 14 are mounted on a bottom of the base 11. However, the structure of the bed frame 10 is not limited by the aforementioned. With reference to FIGS. 19 and 20, the bed frame 10D also may be altered into a wheel chair to be adapted to different situations.

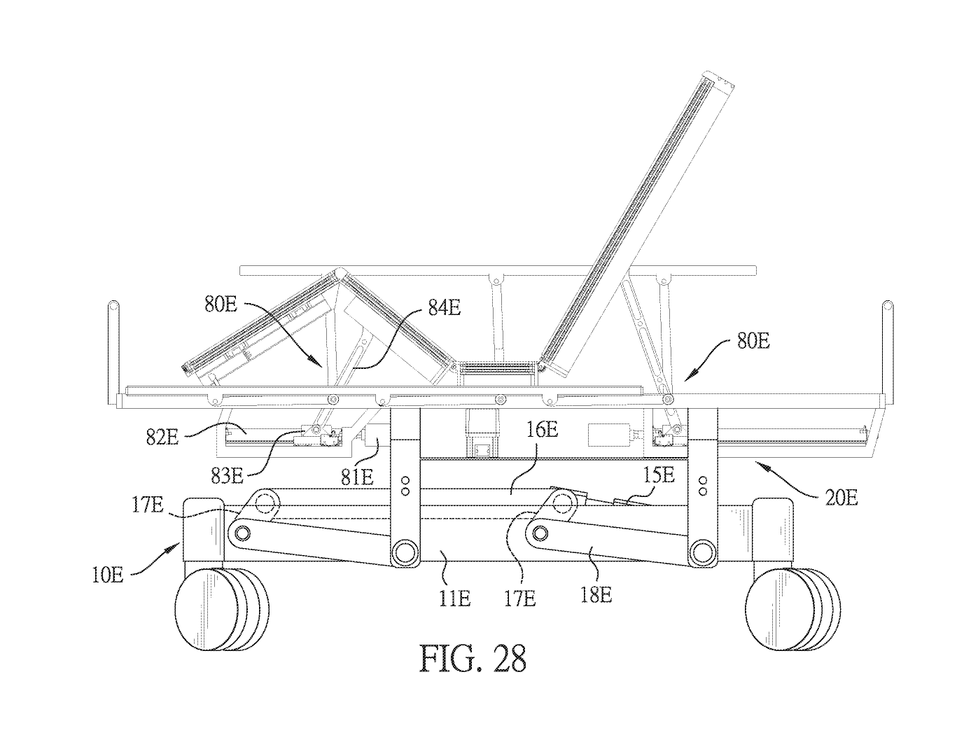

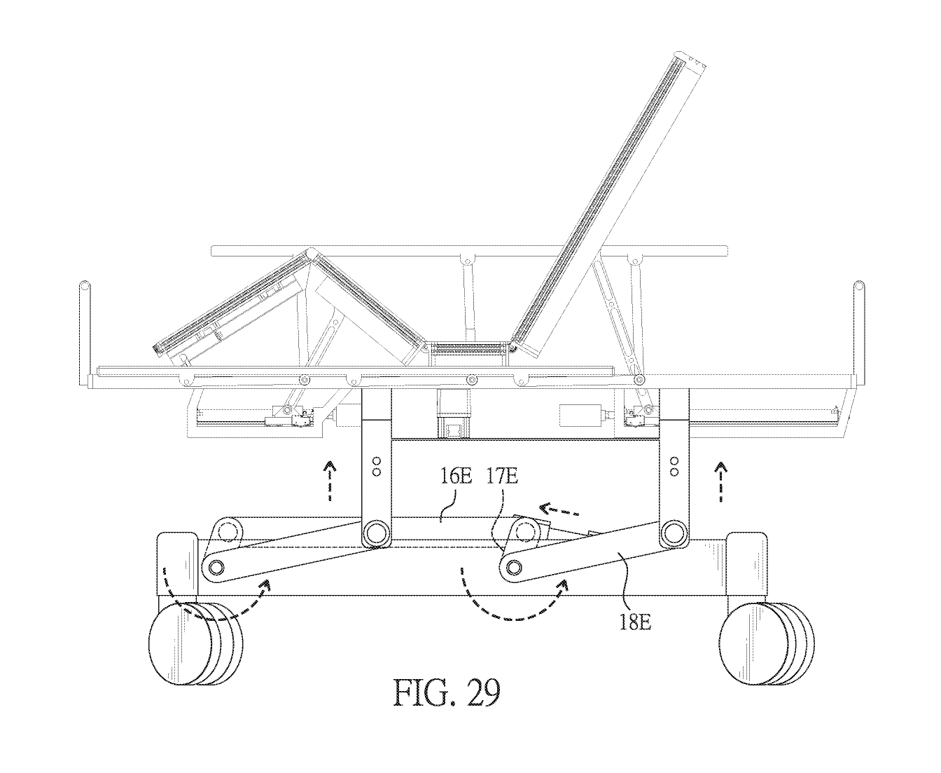

With reference to FIGS. 28 and 29, the bed frame 10E also may have a bed frame power device 15E, a linking frame 16E, multiple inner connecting levers 17E, and multiple outer connecting levers 18E. The bed frame power device 15E is pivotally connected to the base 11E, and has a rod that can protrude outward and retract backward. The bed frame power device 15E may be a hydraulic cylinder. The linking frame 16E is pivotally connected to the bed frame power device 15E. One end of each one of the inner connecting levers 17E is pivotally connected to the base 11E. The other end of said inner connecting lever 17E is pivotally connected to the linking frame 116E. One end of each one of the outer connecting levers 18E is pivotally connected to the base 11E and is rotated by the inner connecting lever 117E. The other end of said outer connecting lever 18E is pivotally connected to the bed-panel unit 20E. Thus, the bed frame power device 15E can rotate the inner connecting levers 17E and the outer connecting levers 18E via the linking frame 16E, thereby elevating the bed-panel unit 20E. With reference to FIGS. 2, 3, and 5, the bed-panel units 20 are mounted on the bed frame 10, and are front-and-rear linearly aligned. Each one of the bed-panel units 20 is rectangular and extends transversely. Each two adjacent ones of the bed-panel units 20 are pivotally connected to each other, such that a relative angle between the two bed-panel units 20 is adjustable, and the patient can keep lying down or remain in a sitting position. In a preferred embodiment, the bending angle of the two bed-panel units 20 is preferably, but not limited to, from 0 to 85 degrees.

In addition, with reference to FIGS. 28 and 29, the bed frame 10E and the bed-panel unit 20E may further have at least one supporting device 80E to support the bed-panel unit 20E, such that each two adjacent ones of the bed-panel units 20E are relatively bendable. In a preferred embodiment, the supporting device 80E has a supporting power device 81E, a threaded rod 82E, a sleeve 83E, and a supporting lever 84E. The supporting power device 81E is mounted on the bed frame 10E, and is for rotating the threaded rod 82E, thereby linearly moving the sleeve 83E which is screwed around the threaded rod 82E. The linear movement of the sleeve 83E further rotates the supporting lever 84E which is pivotally connected to the sleeve 83E, and the supporting lever 84E supports and elevates the bed-panel unit 20E. However, the structure of the supporting device 80E is not limited by the aforementioned, as long as the supporting device 80E can elevate the bed-panel unit 20E.

Each one of the bed-panel units 20 has a mounting frame 21, a moveable bed-panel 22, a transmission shaft 23, and a driven shaft 24.

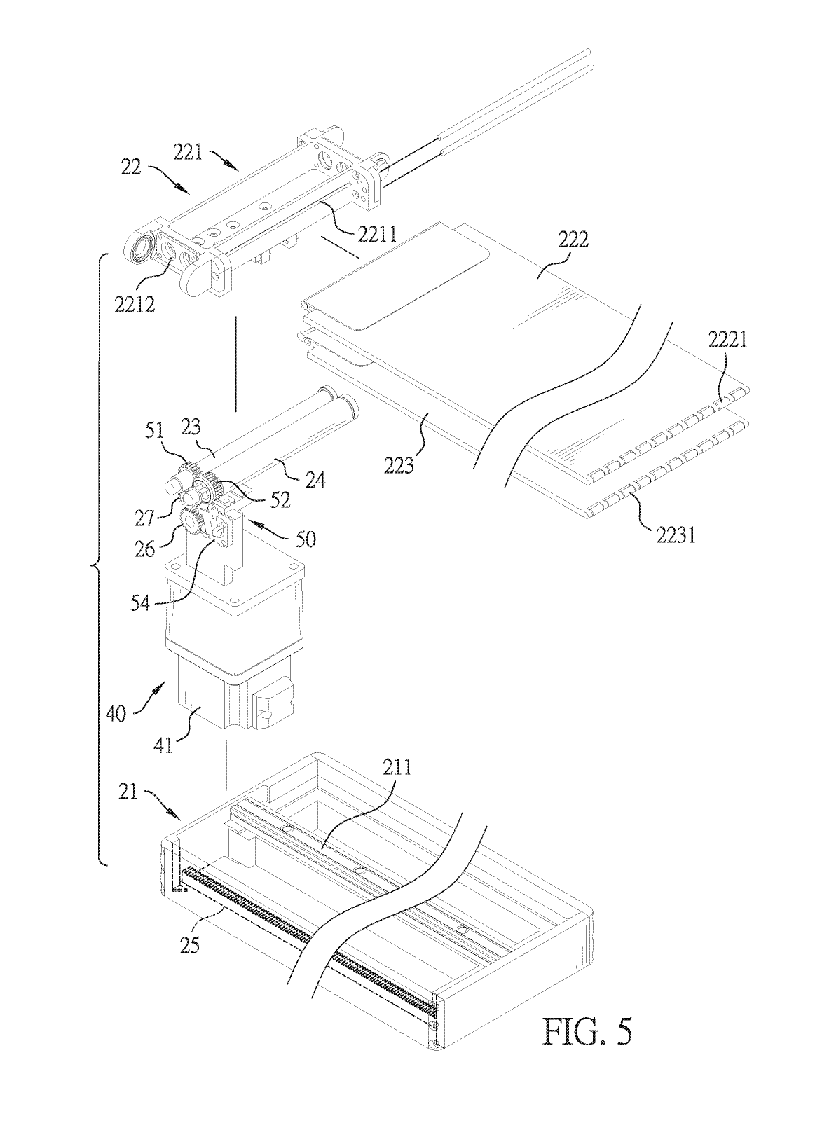

The mounting frame 21 is mounted on the top seat 12 of the bed frame 10. In a preferred embodiment, a top of the mounting frame 21 is mounted with a guiding channel 211 extending transversely as shown in FIG. 5.

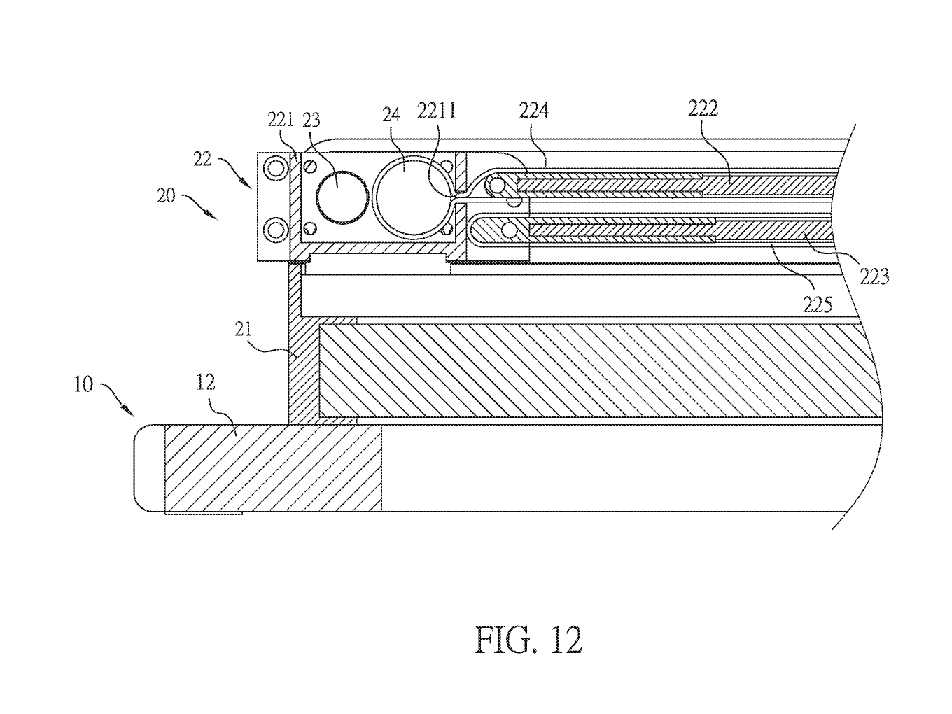

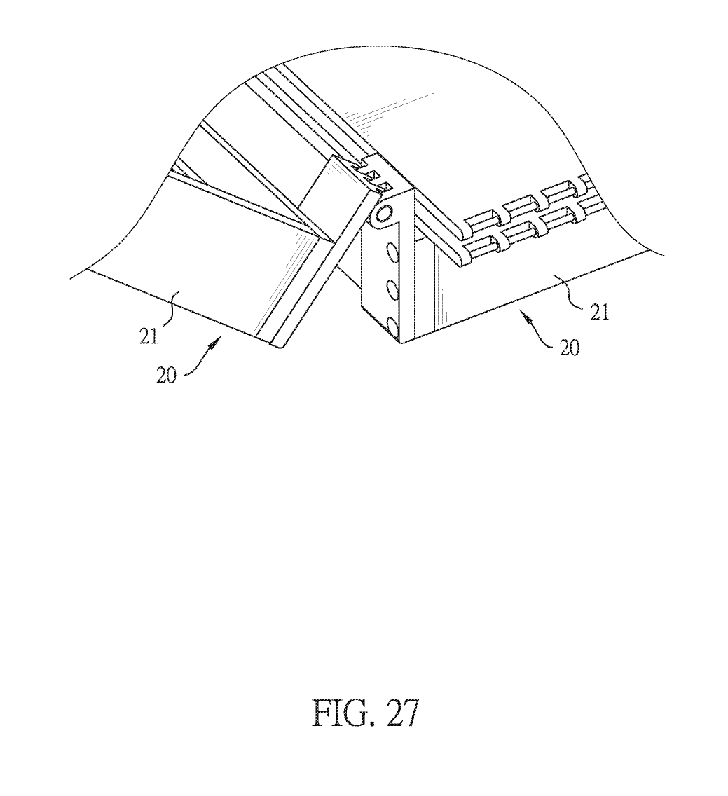

With reference to FIGS. 5, 12 and 13, the moveable bed-panel 22 is transversely movably mounted on the mounting frame 21 along the guiding channel 211. In a preferred embodiment, the two mounting frames 21 of each two adjacent ones of the bed-panel units 20 are pivotally connected to each other as shown in FIG. 27. The two moveable bed-panels 22 of each two adjacent ones of the bed-panel units 20 are pivotally connected to each other. A pivot between the mounting frames 21 and a pivot between the moveable bed-panels 22 are respectively disposed on two sides of the bed-panel unit 20, thereby stabilizing the structure. However, it may be altered as only the two mounting frames 21 are pivotally connected to each other, or only the two moveable bed-panels 22 are pivotally connected to each other.

To be specific, the moveable bed-panel 22 has a shaft seat 221, an upper panel 222, a lower panel 223, an upper looped belt 224, and a lower looped belt 225.

The shaft seat 221 is transversely movably mounted on the mounting frame 21. To be specific, the shaft seat 221 slidably engages the guiding channel 211 on the top of the surface mounting frame 21, thereby stabilizing the relative movement between the shaft seat 221 and the mounting frame 21. The shaft seat 221 is a rectangular frame, and has a top opening for conveniently accommodating other components. But the top opening may be mounted with a cover. An elongated hole 2211 is formed through a side wall of the shaft seat 221. Two shaft holes 2212 are respectively formed through two ends of the shaft seat 221. The transmission shaft 23 and the driven shaft 24 are rotatably mounted in the shaft seat 221, and are respectively mounted through the two shaft holes 2212. In addition, in a preferred embodiment, bearings are mounted between the shaft holes 2212 and the transmission shaft 23 and the driven shaft 24 to facilitate smooth rotation. The two shaft seats 221 of each two adjacent ones of the bed-panel units 20 are pivotally connected to each other.

The upper panel 222 and the lower panel 223 are mounted on a side of the shaft seat 221, and are arranged vertically apart from each other. Multiple rollers 2221, 2231 are respectively mounted on sides of the upper panel 222 and the lower panel 223. The rollers 2221, 2231 and the shaft seat 221 are disposed on opposite sides of the upper panel 222 or the lower panel 223 as shown in FIG. 5.

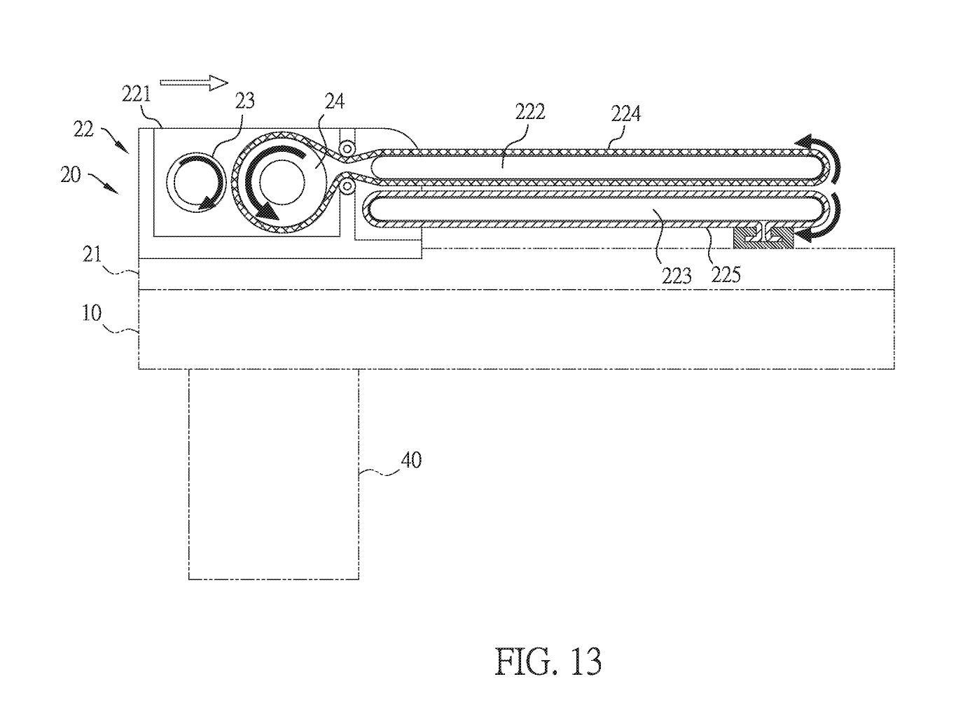

The upper looped belt 224 is mounted around the driven shaft 24 and the upper panel 222, and is rotated by the driven shaft 24 as shown in FIG. 13. To be specific, the upper looped belt 224 passes through the elongated hole 2211 of the shaft seat 221 to surround the driven shaft 24 and the upper panel 222. In addition, the rollers 2221 on the outer side of the upper panel 222 abut an inner surface of the upper looped belt 224 to reduce the friction when the upper looped belt 224 rotates.

The lower looped belt 225 is rotatably mounted around the lower panel 223, and a part of the lower looped belt 225 is fixed on the mounting frame 21 as shown in FIG. 13. When the moveable bed-panel 22 is moved relative to the mounting frame 21, the lower looped belt 225 rotates around the lower panel 223 via the pushing of the lower panel 223. However, the lower looped belt 225 may be rotated by other methods or structure. In addition, the rollers 2231 on the outer side of the lower panel 223 abut an inner surface of the lower looped belt 225 to reduce the friction when the lower looped belt 225 rotates.

In addition, a smooth panel may be mounted between a top of the lower looped belt 225 and a bottom of the upper looped belt 224, thereby reducing the friction between the two looped belts 224, 225. Moreover, in a preferred embodiment, the two looped belts 224, 225 may he made of fabric, nylon or rubber, as long as the material can generate sufficient friction,

In addition, in a preferred embodiment, the upper panel 222 is pivotally connected to the shaft seat 221, and is up-and-down tiltable relative to the shaft seat 221. Therefore, the upper looped belt 224 is mounted around the upper panel 222 and the driven shaft 24 when the upper panel 222 is tilted upward. Then, when the upper panel 222 is rotated to be horizontal, the upper panel 222 can abut and tighten the upper looped belt 224.

The transmission shaft 23 and the driven shaft 24 are rotatably mounted in the shaft seat 221 as mentioned above. To be specific, axes of the transmission shaft 23 and the driven shaft 24 are perpendicular to a pivot axis between each two adjacent shaft seats 221.

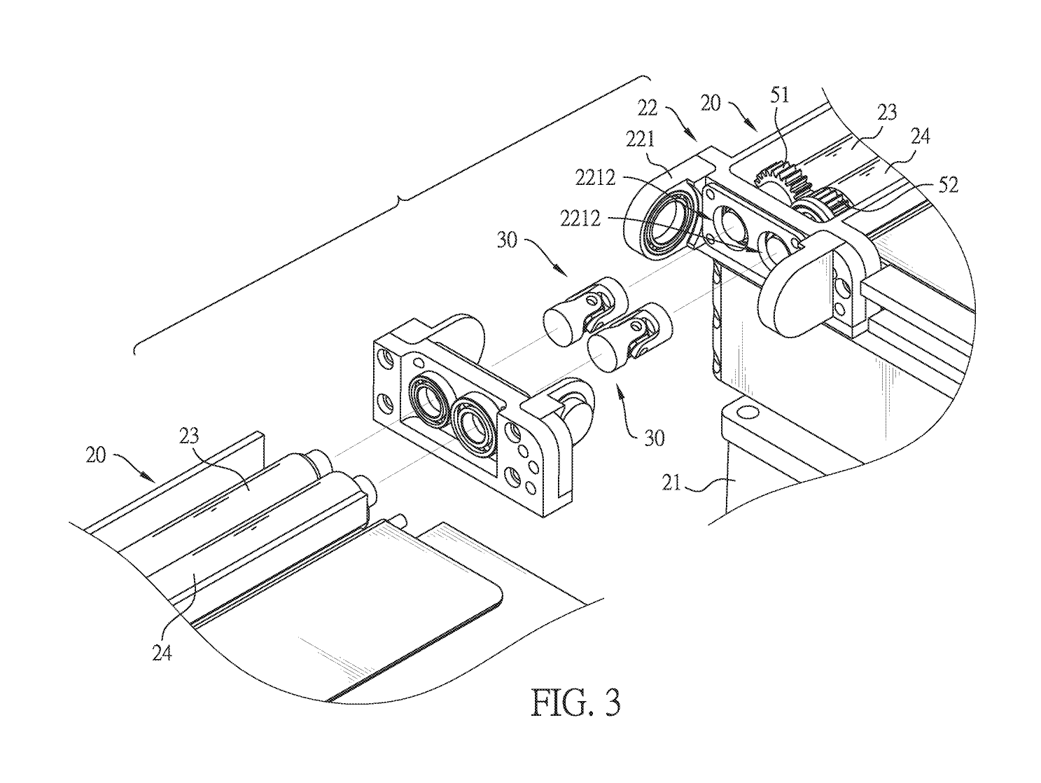

With reference to FIG. 3, the two transmission shafts 23 of each two adjacent ones of the bed-panel units 20 are connected by a coupling 30. The two driven shafts 24 of each two adjacent ones of the bed-panel units 20 are also connected by a coupling 30. Therefore, when the transmission shaft 23 and the driven shaft 24 of a single one of the bed-panel units 20 rotate, the transmission shafts 23 and the driven shafts 24 of all the bed-panel units 20 rotate as well via the couplings 30. In addition, even though the two transmission shafts 23 or the two driven shafts 24 on both sides of the coupling 30 are unparallel, the coupling 30 also can transmit the rotation.

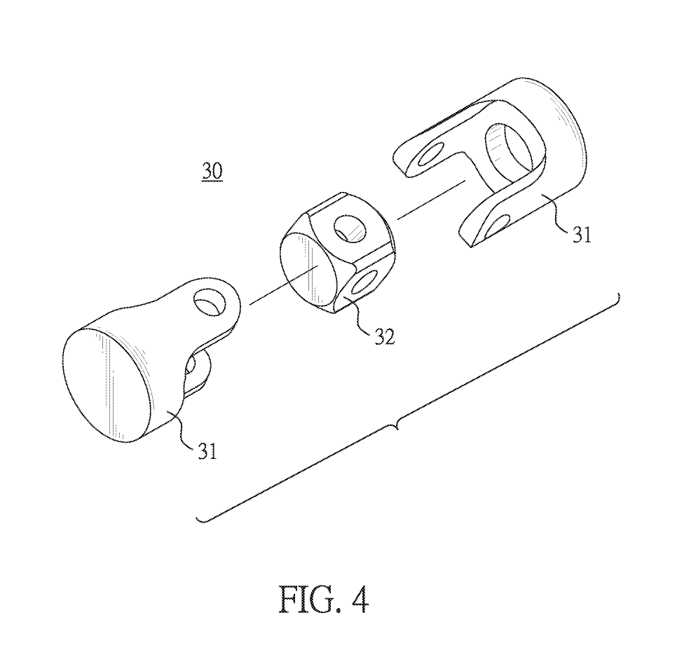

With reference to FIG. 4, in a preferred embodiment, the coupling 30 is a universal joint, and has two mounting seats 31 and an intermediate element 32. The two mounting seats 31 are respectively pivotally connected to the intermediate element 32, and two pivot shafts of the two mounting seats 31 are perpendicular to each other.

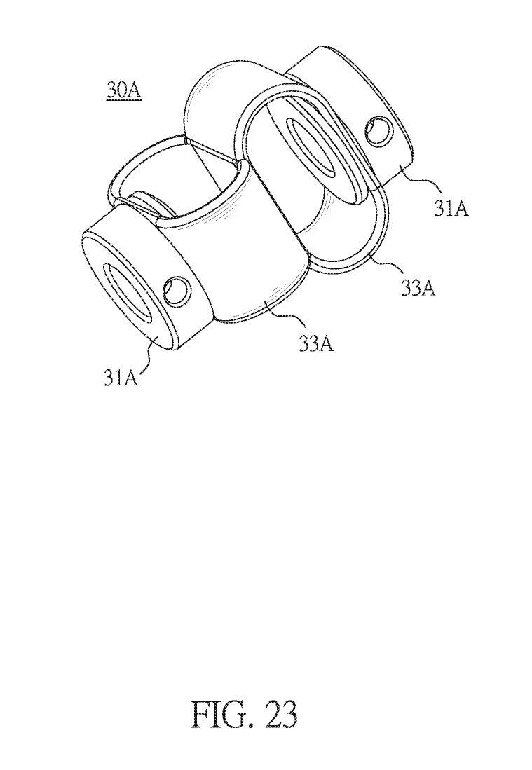

However, with reference to FIG. 23, the coupling 30A also may be a flexible universal shaft connector. That is, two mounting seats 31A are connected by two flexible units 33A.

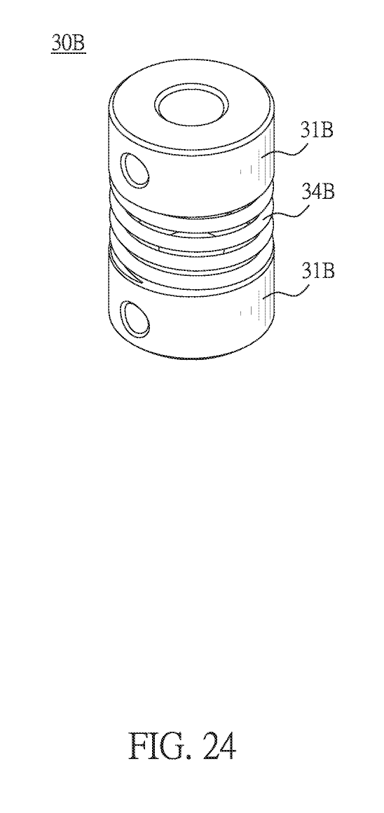

Or, with reference to FIG. 24, the coupling 30B may be a spring universal shaft connector. That is, two mounting seats 31B are connected by a spring 34B.

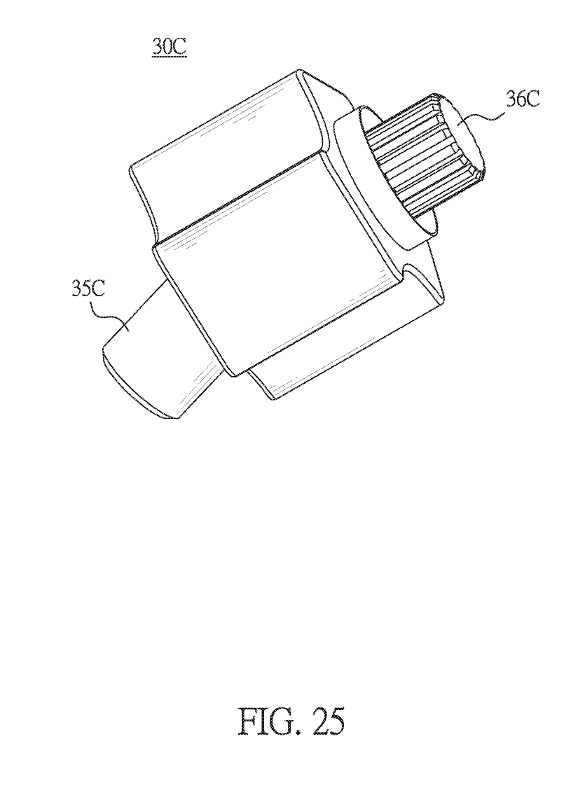

Or, with reference to FIG. 25, the coupling 30C may be a constant velocity joint, which has a rod 35C and a cover 36C. One end of the rod 35C is connected to one of the transmission shaft 23 and the driven shaft 24. The other end of the rod 35C is disposed in the cover 36C and is freely rotatable relative to the cover 36C. A rod part protrudes from the cover 36C to connect to the other one of the transmission shaft 23 and the driven shaft 24.

However, the form and the structure of the coupling 30 are not limited by the aforementioned, as long as the coupling 30 can transmit rotation between two unparallel shafts.

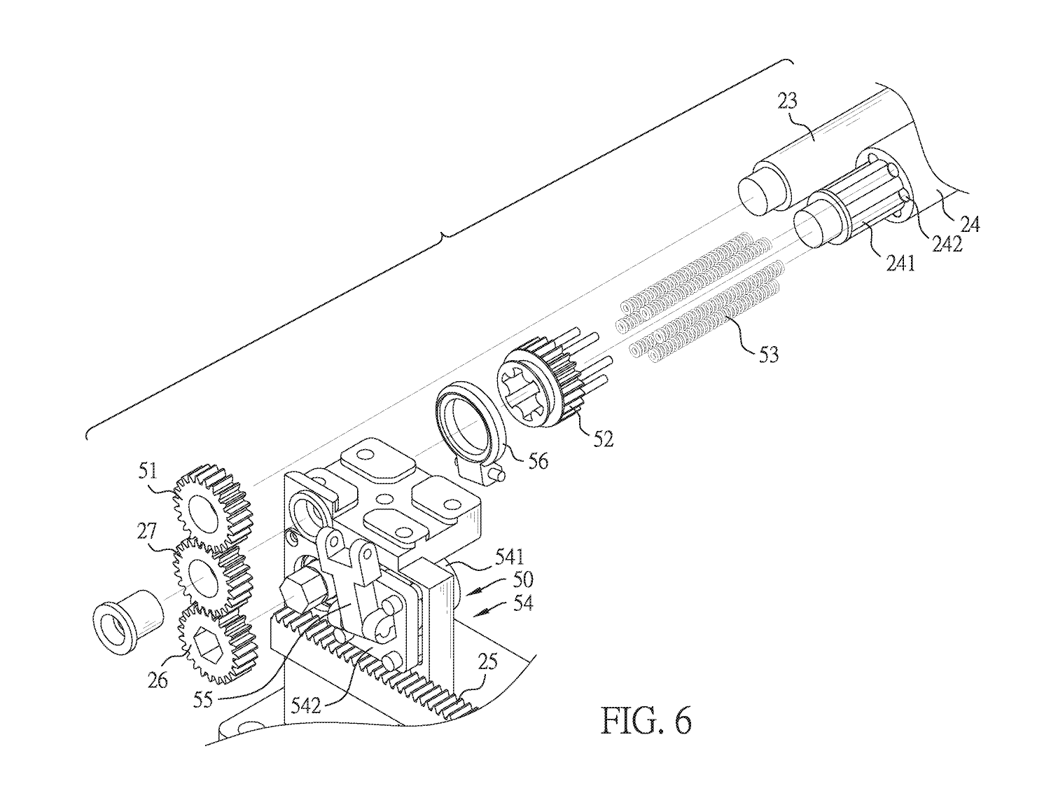

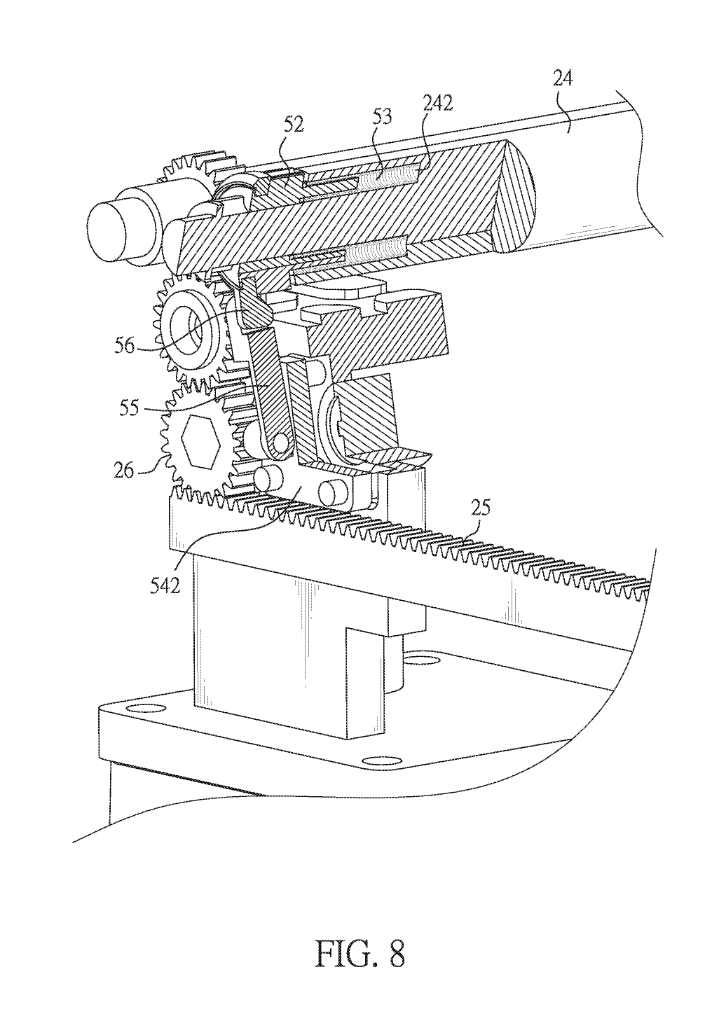

With reference to FIGS. 5 to 8, the transmission shaft 23 is for moving the moveable bed-panel 22 relative to the mounting frame 211 To be specific, one of the bed-panel units 20 further has a gear rack 25 and a moving gear 26. The gear rack 25 is mounted on the top of the mounting frame 21. The moving gear 26 is mounted on the moveable bed-panel 22, and engages with the gear rack 25. As such, when the transmission shaft 23 rotates the moving gear 26, the transmission shaft 23 and the moving gear 26 are moved along the gear rack 25 to make the moveable bed-panel 22 moved relative to the mounting frame 21.

When the moving gear 26 rotates, the moving gear 26 makes the overall moveable bed-panel 22 move relative to the mounting frame 21 along the gear rack 25. The moving gear 26 and the transmission shaft 23 can rotate each other.

For example, in a preferred embodiment, the bed-panel power device 40 rotates the moving gear 26 of one of the bed-panel units 20, and the moving gear 26 is rotated relative to the gear rack 25 and rotates the transmission shaft 23 at the same time. Then the transmission shaft 23 rotates the transmission shafts 23 of other bed-panel units via the couplings 30. Thus, the moving gears 26 of the other bed-panel units 20 are rotated as well, such that the moveable bed-panels 22 of all the bed-panel units 20 can be moved together via the respective moving gear 26 and the respective gear rack 25. However, the transmission is not limited by the aforementioned. The bed-panel power device 40 also can directly rotate the transmission shaft 23, and then the transmission shaft 23 rotates the moving gear 26.

In a preferred embodiment, it also can be implemented that each one of the bed-panel units 20 has the moving gear 26 and the gear rack 25. But is also can be implemented that only a part of the bed-panel units 20 have the moving gear 26 and the gear rack 25. Or even only one of the bed-panel units 20 has the moving gear 26 and the gear rack 25, which also can rotate the moveable bed-panel 22 of the adjacent bed-panel unit 20 via the pivot mechanism between the two shaft seats 221 of each two adjacent ones of the bed-panel units 20.

In addition, the transmission shaft 23 also can move the moveable bed-panel 22 relative to the mounting frame 21 in any other method other than the moving gear 26 and the gear rack 25. For example, the moving gear 26 may be replaced as a roller, and the roller abuts on the mounting frame 21, such that the transmission shaft 23 still can rotate the roller to move the moveable bed-panel 22.

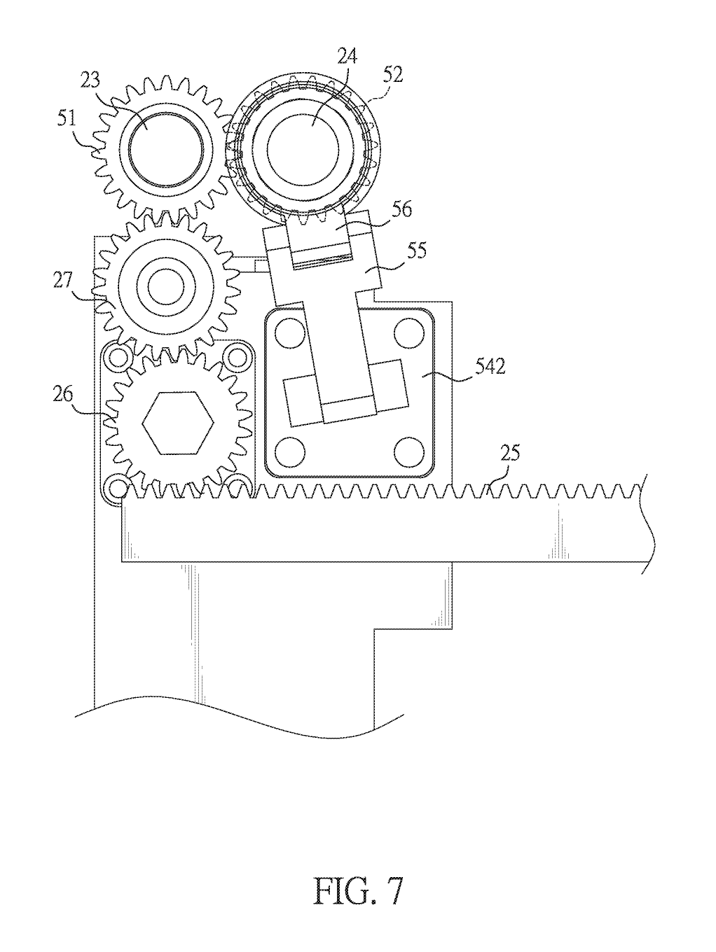

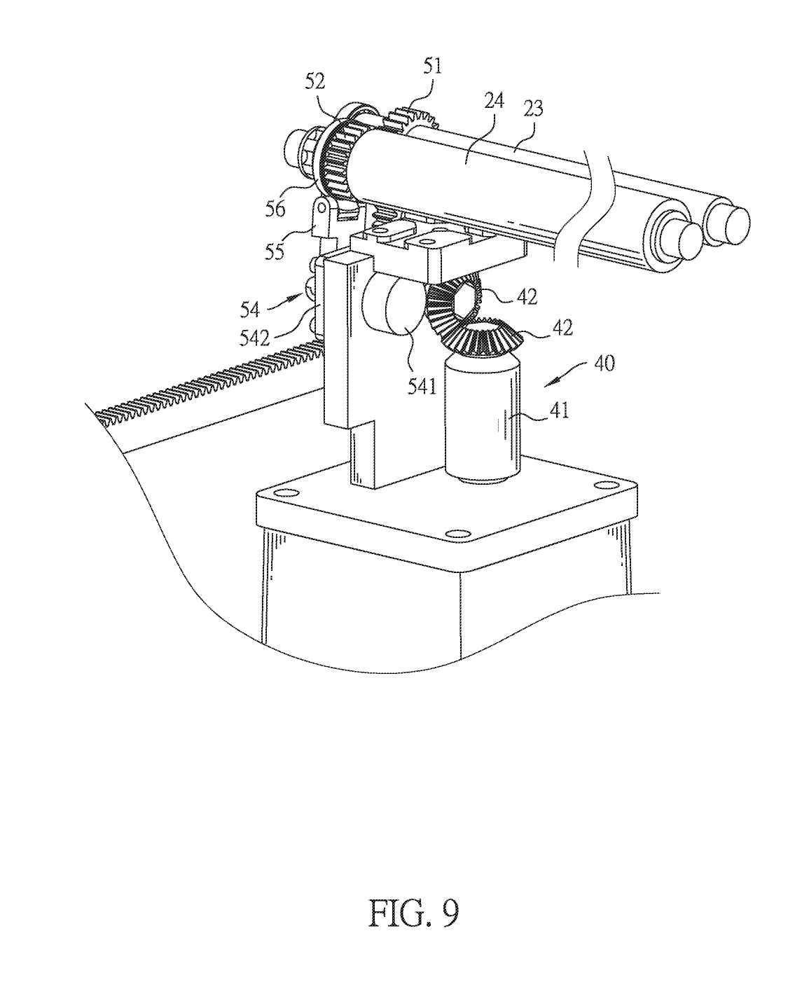

With reference to FIGS. 7 to 9, in a preferred embodiment, the bed-panel power device 40 is mounted on a bottom of the shaft seat 221 of the moveable bed-panel 22 of one of the bed-panel units 20, and the bed-panel power device 40 has a motor 41. An output shaft of the motor 41 rotates the moving gear 26 of the moveable bed-panel 22 via two bevel gears 42. A first clutch gear 511 is mounted securely around the transmission shaft 23. The moving gear 26 rotates the first clutch gear 51 and the transmission shaft 23 via a driven gear 27. In addition, the output shaft of the motor 41 can rotate clockwise and counterclockwise. However, the structure and the transmission of the bed-panel power device 40 are not limited by the aforementioned, as long as the bed-panel power device 40 can directly or indirectly rotate the transmission shaft 23.

The transmission shaft 23 and the driven shaft 24 can be driven by the same power source or can be driven by different power sources respectively. With reference to FIGS. 5 to 9, in a preferred embodiment, the transmission shaft 23 and the driven shaft 24 are driven by the same power source, and thus a clutch 50 is installed to make the transmission shaft 23 selectively rotate the driven shaft 24. The clutch 50 is mounted on one of the bed-panel units 20, and has the first clutch gear 51 mentioned above, a second clutch gear 52, multiple resilient elements 53, and a clutch power device 54.

The first clutch gear 51 is mounted securely around the transmission shaft 23 as mentioned above. The second clutch gear 52 is movably mounted around the driven shaft 24, but is unrotatable [symbol] ; irrotational [symbol] [symbol] , [symbol] unrotatable [symbol] , [symbol] , [symbol] [symbol] relative to the driven shaft 24. In other words, the second clutch gear 52 rotates the driven shaft 24. To be specific, an end of the driven shaft 24 is transversely formed with multiple key recesses 241 The second clutch gear 52 is mounted around and engages with the key recesses 241 to rotate the driven shaft 24. In addition, side walls of the key recesses 241 are axially formed with multiple resilient element recesses 42 to accommodate the resilient elements 53. Outer ends of the resilient elements 53 abut and push the second clutch gear 52 to make the second clutch gear 52 separating from the first clutch gear 51. Therefore, the transmission shaft 23 does not rotate the driven shaft 24 normally.

The clutch power device 54 is mounted below the shaft seat 221, is connected to the second clutch gear 52, and can push the second clutch gear 52 to make the second clutch gear 52 engage the first clutch gear 511, such that the transmission shaft 23 can rotate the driven shaft 24. To be specific, the clutch power device 54 has an electromagnet 541 and a clutch armature 542. An end of a clutch connecting rod 55 is pivotally connected to a side wall of the clutch armature 542. A clutch blocking ring 56 is pivotally connected to the other end of the clutch connecting rod 55, and is mounted securely around the second clutch gear 52.

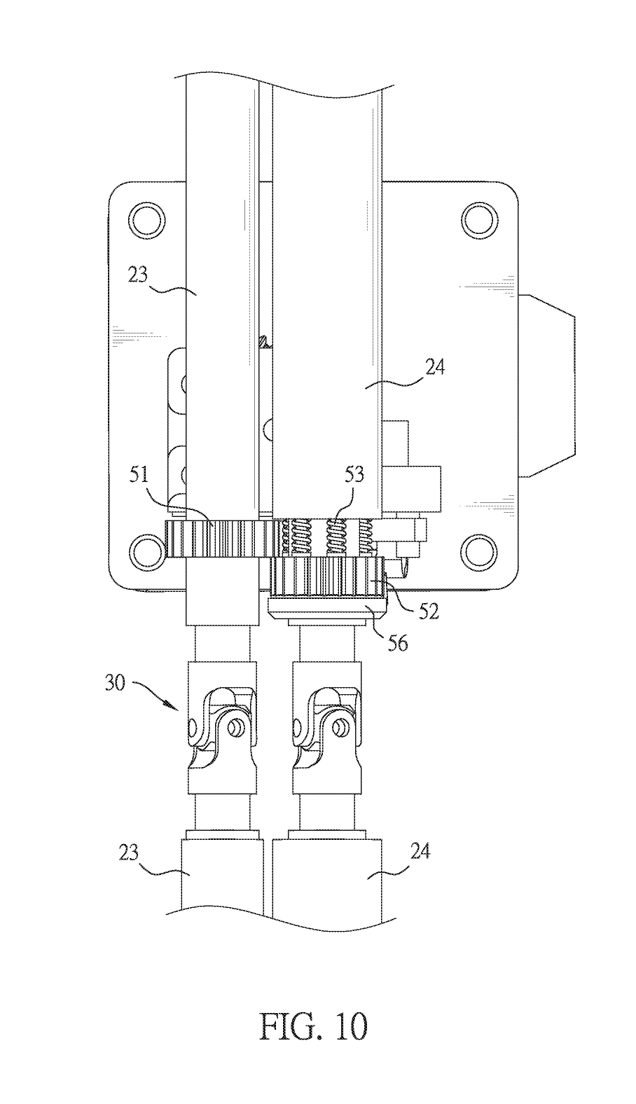

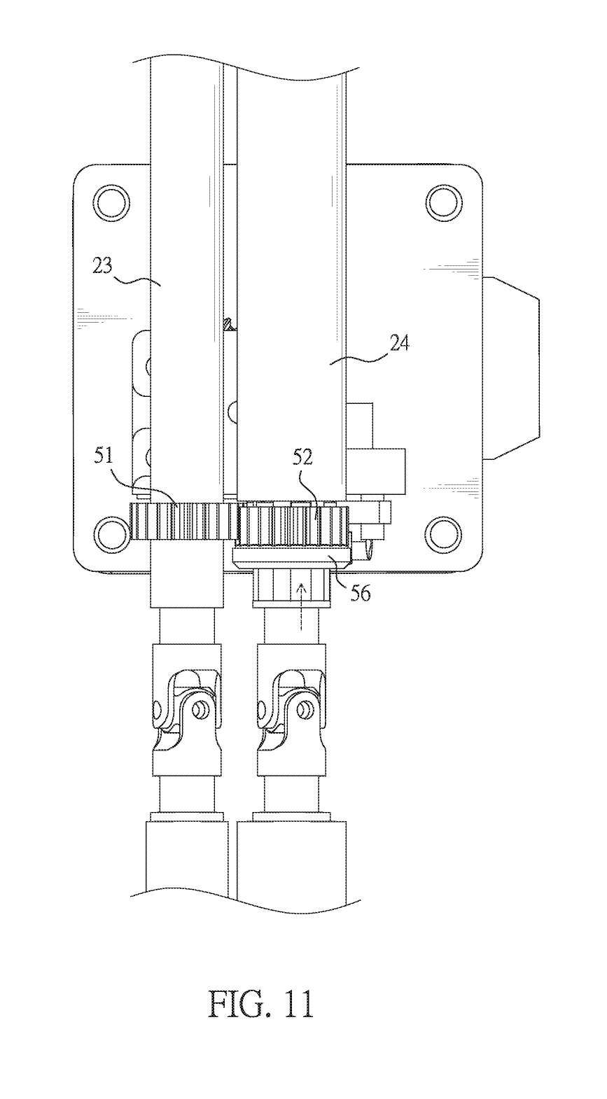

With reference to FIGS. 10 and 11, when the electromagnet 541 receives a signal and is actuated, the electromagnet 541 magnetically attracts the clutch armature 542. The movement of the clutch armature 542 moves the clutch blocking ring 56 via the clutch connecting rod 55 to further push the second clutch gear 52, thereby engaging the second clutch gear 52 with the first clutch gear 51. When the electromagnet 541 is switched off, the resilient elements 53 push back the aforementioned components to separate the second clutch gear 52 from the first clutch gear 51.

Operation of the present invention in use is divided into four stages. The following is an example that the patient is moved from the operating table to the hospital bed.

With reference to FIG. 13, first, the second clutch gear 52 engages with the first clutch gear 51, and the transmission shaft 23 rotates to move the moveable bed-panel 22 out of a top of the mounting frame 21. Thus, the upper panel 222, the lower panel 223, the upper looped belt 224, and the lower looped belt 225 are inserted between the back of the patient and the operating table. At this time, the driven shaft 24 counterclockwise rotates the upper looped belt 224 to facilitate convenience in moving the patient to the upper panel 222 and the upper looped belt 224 gradually, thereby avoiding pushing the patient along with the movement of the moveable bed-panel 22. The lower looped belt 225 clockwise rotates, such that the lower looped belt 225 can be smoothly moved to be on the operating table and the rotation of the lower looped belt 225 can decrease the friction from the operating table.

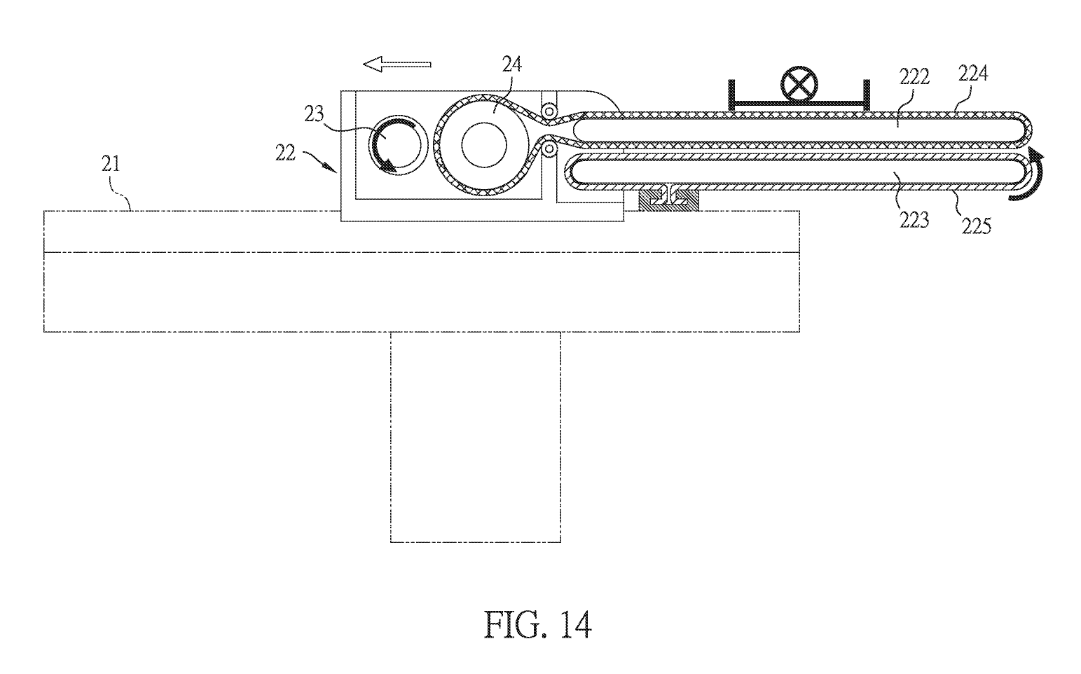

With reference to FIG. 14, then the second clutch gear 52 separates from the first clutch gear 51, and the transmission shaft 23 rotates reversely to move the moveable bed-panel 22 back on the mounting frame 21. At this time, the driven shaft 24 and the upper looped belt 224 do not rotate, such that the upper panel 222 and the upper looped belt 224 with the patient are moved back to the mounting frame 21. The lower looped belt 225 counterclockwise rotates, such that the lower looped belt 225 can be smoothly moved out of the operating table.

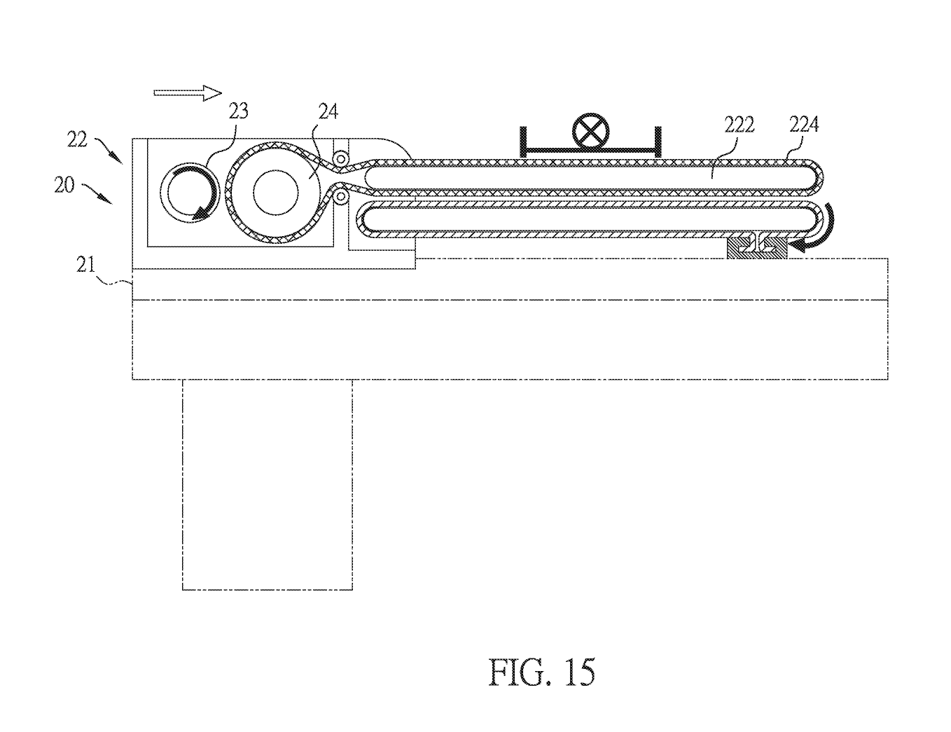

With reference to FIG. 15, then the present invention is moved to be next to the hospital bed. Afterwards, the second clutch gear 52 separates from the first clutch gear 51, and the transmission shaft 23 rotates to move the moveable bed-panel 22. The moveable bed-panel 22 is moved out of the mounting frame 21, and is moved to be on the hospital bed. At this time, the driven shaft 24 and the upper looped belt 224 do not rotate, such that the upper panel 222 and the upper looped belt 224 with the patient are moved out of the mounting frame 21. The lower looped belt 225 clockwise rotates, such that the lower looped belt 225 can be smoothly moved to be on the hospital bed.

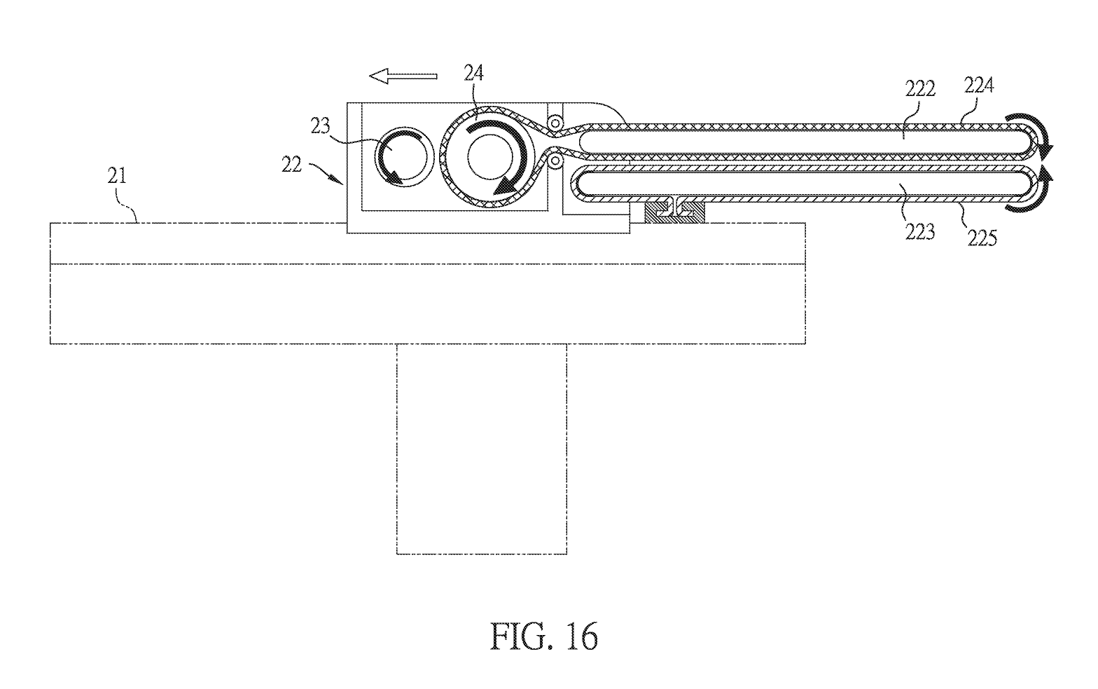

With reference to FIG. 16, finally, the second clutch gear 52 engages with the first clutch gear 5:1, and the transmission shaft 23 rotates reversely to move the moveable bed-panel 22 back to the mounting frame 21. At this time, the driven shaft 24 clockwise rotates the upper looped belt 224 to facilitate convenience in moving the patient gradually out of the upper panel 222 and the upper looped belt 224 to the hospital bed. The lower looped belt 225 counterclockwise rotates, such that the lower looped belt 225 can be smoothly moved out of the hospital bed.

The aforementioned movement can smoothly move the patient. The clutch 50 enables the transmission shaft 23 and the driven shaft 24 to be driven by the same power source to simplify the overall structure.

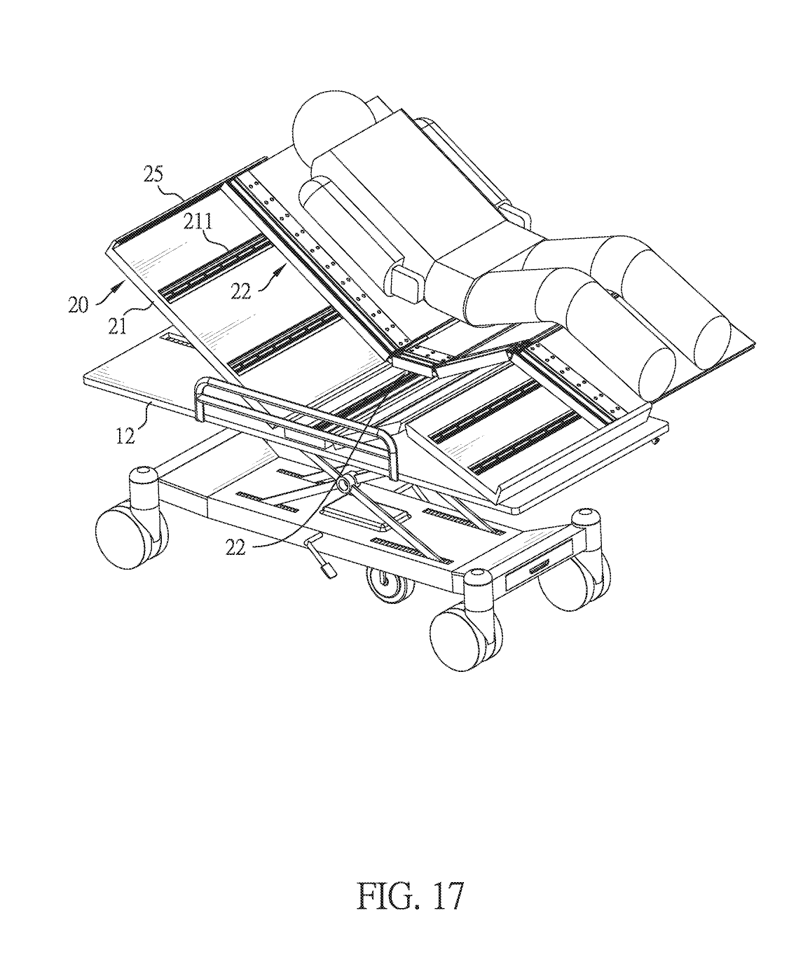

With reference to FIGS. 3 and 17, in addition, during the aforementioned movement, the moveable bed-panels 22 of the bed-panel units 20 are connected by the couplings 30, such that the moveable bed-panels 22 can be moved when the bed-panel units 20 are bent relative to each other. Therefore, the patient can be moved when in the sitting position or when bending his knees.

Particularly when the patient is in the sitting position, the vision of the patient is relatively broad and wide. The patient can see the present invention beside him simply by slightly turning his head without turning his body. In addition, the present invention can be operated and controlled by an app (application) on the smart phone, thereby facilitating convenience in operating for the patient. Thus the present invention is also adapted to patients with paralysis.

With reference to FIGS. 19 and 20, the bed frame 10D also may be altered into a wheel chair. In this preferred embodiment, the transferring bed may be further mounted with a power device to rotate the rollers 14D, thereby making the transferring bed function as a vehicle. Therefore, even though the patient who can only move his hand and head, the patient can also move to other places from the hospital bed by himself alone by operating the present invention.

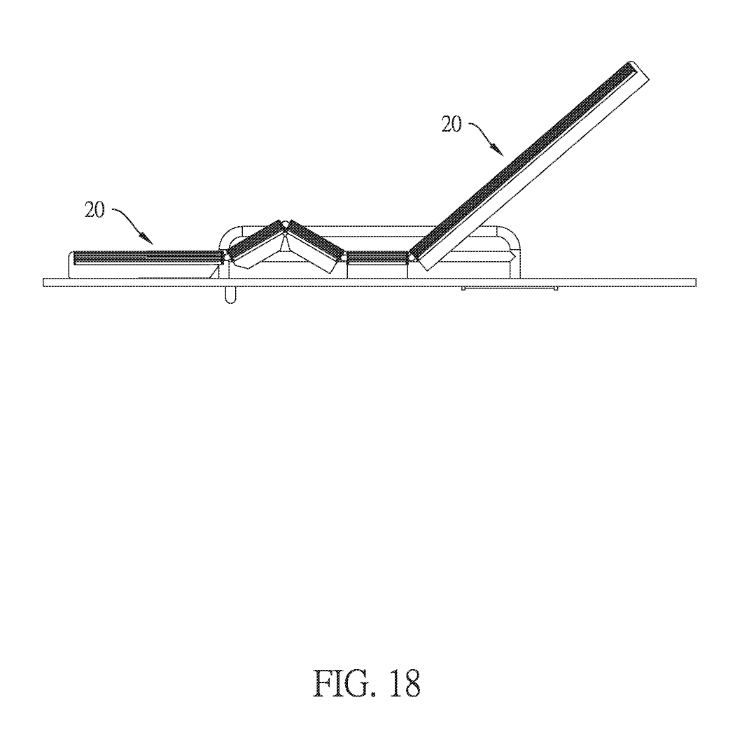

In addition, in a preferred embodiment, an amount of the bed-panel units 20 is four, such that the hack of the patient can be raised and the knees of the patient can be bent. But the amount of the bed-panel unit 20 is not limited by four, and may be altered into other numbers. With reference to FIG. 18, an amount of the bed-panel units 20 may be five, thereby affording more bending methods adjustable for children of different heights. Besides, an amount of the bed-panel units 20 may be two, which is sufficient to afford the basic function to make the patient remain in the sitting position. Furthermore, when an amount of the bed-panel units 20 is two and the driven shaft is omitted, the present invention only needs one single coupling.

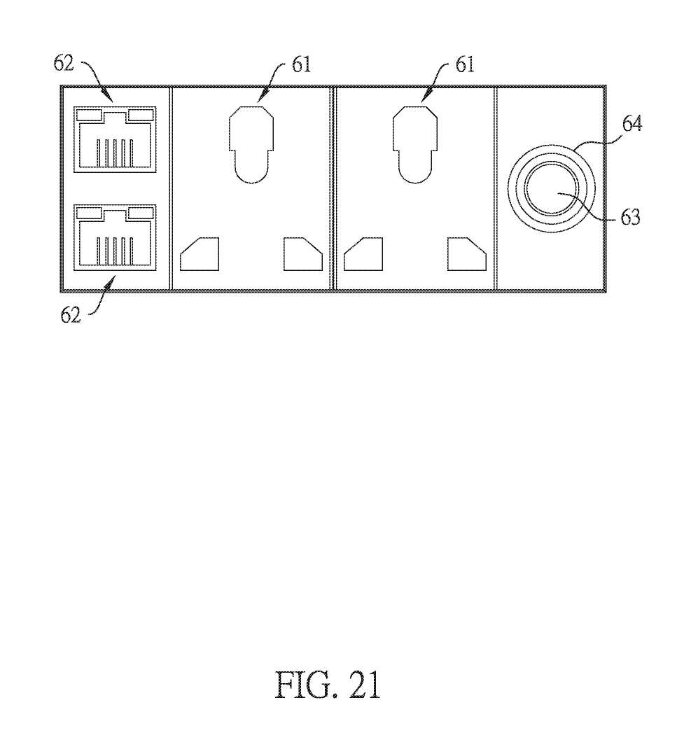

With reference to FIG. 21, the present invention provides a 110/220V universal multifunction power interface 61 and a data transfer port 62 such as a RJ45 port and a RS232 port. The universal multifunction power interface 61 [symbol] : [symbol] interface [symbol] , [symbol] [symbol] [symbol] supplies power for a common clinical medical equipment such as a multi-parameter monitor and a ventilator. A power switch 63 controls the universal multifunction power interface 61, and a power indicator 64 displays whether the universal multifunction power interface 61 is switched on or off. The data from the monitor is transmitted to the mother board of the present invention via the RJ45 port or the RS232 port, and the mother hoard of the present invention processes the vital sign data of the patient to determine how to operate.

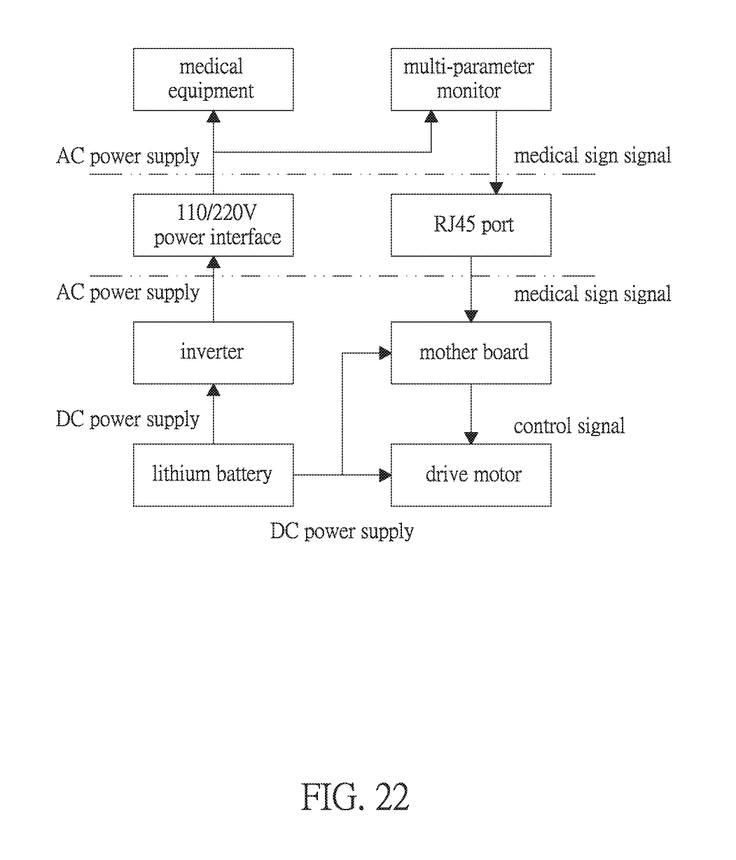

With reference to FIG. 22, the present invention may be powered by a large capacity lithium battery. The lithium battery supplies power for the mother hoard and the drive motor, and produces 110/220V AC through an inverter to supply power for the common clinical medical equipment such as the multi-parameter monitor and the ventilator. The data from the monitor is transmitted to the mother board of the present invention via the RJ45 port or the RS232 port, and the mother board of the present invention processes the vital sign data of the patient to determine the condition of the patient, thereby selecting a suitable operating method and generating a signal to actuate the corresponding motor to perform the suitable operating method.

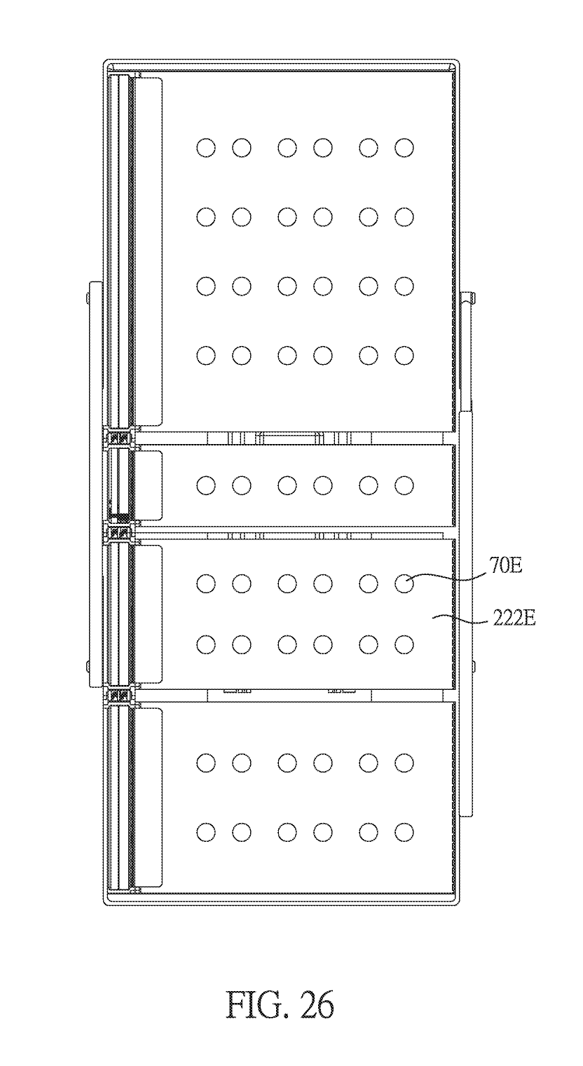

With reference to FIG. 26, in another preferred embodiment, multiple flexible pressure sensors 70E are mounted on a top of the upper panel 222E to form a patient body position sensor array. When the patient is on the present invention, the array of the pressure sensors 70E can identify the position of the patient on the upper panel 222E. If the patient is much away from the center of the upper panel 222E to the extent that the patient may fall down during the movement of the upper panel 222E, the present invention may generate alarm and call the related personnel. Accurately knowing the position of the patient on the upper panel 222E does help in the operating of the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A bendable transferring bed comprising:
a bed frame;
multiple bed-panel units mounted on the bed frame and linearly aligned; each two adjacent ones of the bed-panel units pivotally connected to each other, each one of the bed-panel units having
a mounting frame mounted on the bed frame;
a moveable bed-panel movably mounted on the mounting frame; and
a transmission shaft rotatably mounted on the moveable bed-panel; wherein the moveable bed-panel is moved relative to the mounting frame through the rotating of the transmission shaft;
at least one coupling; wherein the two transmission shafts of each two adjacent ones of the bed-panel units are connected by one of the at least one coupling; and
a bed-panel power device mounted on one of the bed-panel units, and rotating the transmission shaft of said bed-panel unit.

2. The bendable transferring bed as claimed in claim 1, wherein each one of the at least one coupling is a universal joint.

3. The bendable transferring bed as claimed in claim 1, wherein each one of the at least one coupling is a flexible universal shaft connector.

4. The bendable transferring bed as claimed in claim 1, wherein each one of the at least one coupling is a spring universal shaft connector.

5. The bendable transferring bed as claimed in claim 1, wherein each one of the at least one coupling is a constant velocity joint.

6. The bendable transferring bed as claimed in claim 1, wherein each one of the at least one bed-panel units has
a gear rack mounted on the mounting frame; and
a moving gear mounted on the moveable bed-panel, rotated by the transmission shaft, and engaging with the gear rack; wherein the transmission shaft rotates the moving gear, such that the transmission shaft and the moving gear are moved along the gear rack to make the moveable bed-panel moved relative to the mounting frame.

7. The bendable transferring bed as claimed in claim 1, wherein
each one of the bed-panel units further has
a driven shaft rotatably mounted on the moveable bed-panel; wherein the two driven shafts of each two adjacent ones of the bed-panel units are connected by one of the at least one coupling;
the bendable transferring bed further has
a clutch mounted on one of the bed-panel units to make the driven shaft of said bed-panel unit selectively rotated by the transmission shaft; and
the moveable bed-panel of each one of the bed-panel units has
a shaft seat movably mounted on the mounting frame; wherein the transmission shaft and the driven shaft are rotatably mounted in the shaft seat; wherein the two shaft seats of the two moveable bed-panels of each two adjacent ones of the bed-panel units are pivotally connected to each other;
an upper panel mounted on a side of the shaft seat;
an upper looped belt mounted around the driven shaft and the upper panel, and rotated by the driven shaft;
a lower panel mounted on the side of the shaft seat; and
a lower looped belt rotatably mounted around the lower panel.

8. The bendable transferring bed as claimed in claim 7, wherein the clutch has
a first clutch gear mounted around the transmission shaft;
a second clutch gear movably mounted around the driven shaft;
multiple resilient elements mounted between the driven shaft and the second clutch gear, and pushing the second clutch gear to make the second clutch gear separating from the first clutch gear; and
a clutch power device connected to the second clutch gear, and capable of pushing the second clutch gear to make the second clutch gear engaged with the first clutch gear.

9. The bendable transferring bed as claimed in claim 7, wherein a part of the lower looped belt is fixed on the mounting frame of the bed-panel unit.

10. The bendable transferring bed as claimed in claim 7, wherein the moveable bed-panel further has
a smooth panel mounted between a top of the lower looped belt and a bottom of the upper looped belt.

11. The bendable transferring bed as claimed in claim 7, wherein the moveable bed-panel further has
multiple rollers mounted on the upper panel and abutting an inner surface of the upper looped belt; and
multiple rollers mounted on the lower panel and abutting an inner surface of the lower looped belt.

12. The bendable transferring bed as claimed in claim 1, wherein each one of the bed-panel units has multiple flexible pressure sensors mounted on the moveable bed-panel.
